(19) United States
(12) Patent Application Publication
(10) Pub. No.: US 2020/0105150 A1
(43) Pub. Date: Apr. 2, 2020

(54) UNMANNED AIRCRAFT RETURN FLIGHT CONTROL METHOD, DEVICE, AND UNMANNED AERIAL VEHICLE

(71) Applicant: SZ DJI TECHNOLOGY CO., LTD., Shenzhen (CN)

(72) Inventors: Canlong LIN, Shenzhen (CN); Li WANG, Shenzhen (CN)

(21) Appl. No.: 16/685,517

(22) Filed: Nov. 15, 2019

Related U.S. Application Data
(63) Continuation of application No. PCT/CN2017/085773, filed on May 24, 2017.

(51) Int. Cl. G08G 5/00; G05D 1/00; B64C 39/02

(52) U.S. Cl. CPC G08G 5/0069; G08G 5/0013; B64C 2201/14; G05D 1/0022; B64C 39/024; G08G 5/003

(57) ABSTRACT

A method for controlling return flight of an unmanned aircraft includes receiving location information of an updated return flight location transmitted from a ground terminal. The method also includes determining a target flight path based on a current velocity, current location information, and location information of the updated return flight location of the unmanned aircraft. The method further includes controlling the unmanned aircraft to return flight toward the updated return flight location based on the target flight path.

### CROSS-REFERENCE TO RELATED APPLICATION

This application is a continuation application of International Application No. PCT/CN2017/085773, filed on May 24, 2017, the entire content of which is incorporated herein by reference.

### TECHNICAL FIELD

The present disclosure relates to the technology field of unmanned aircrafts and, more particularly, to an unmanned aircraft return flight control method, a device, and an unmanned aircraft.

### BACKGROUND

In current technologies, unmanned aircrafts may be equipped with an automatic return flight function. For example, if during the flight of the unmanned aircraft, the unmanned aircraft receives a return flight command transmitted by a control terminal, the unmanned aircraft automatically returns to the flight-starting location.

However, during the return flight of the unmanned aircraft, the return flight location may be changed. When the unmanned aircraft receives information of a new return flight location transmitted by a ground terminal, the unmanned aircraft may decelerate and hover immediately, re-plan a flight path from the current hover location to the new return flight location, and restart the return flight at a zero speed flight state until the unmanned aircraft arrives at the new return flight location. As such, velocity interruption and return flight process discontinuity occur during the return flight of the unmanned aircraft, which may cause the unmanned aircraft to be unable to smoothly transition from the original flight path to the newly planned flight path.

### SUMMARY

In accordance with an aspect of the present disclosure, there is provided a method for controlling return flight of an unmanned aircraft. The method includes receiving location information of an updated return flight location transmitted from a ground terminal. The method also includes determining a target flight path based on a current velocity, current location information, and location information of the updated return flight location of the unmanned aircraft. The method further includes controlling the unmanned aircraft to return flight toward the updated return flight location based on the target flight path.

In accordance with another aspect of the present disclosure, there is provided a device for controlling return flight of an unmanned aircraft. The device includes a receiver configured to receive location information of an updated return flight location transmitted from a ground terminal. The device also includes one or more processors communicatively coupled with the receiver. The one or more processors are configured to operate independently or in combination to determine a target flight path based on a current velocity, current location information, and the location information of the updated return flight location of the unmanned aircraft. The one or more processors are also configured to control the unmanned aircraft to return flight toward the updated return flight location based on the target flight path.

According to the unmanned aircraft return flight control method, device, and unmanned aircraft of the present disclosure, when the unmanned aircraft receives information of an updated return flight location transmitted by a ground terminal, the unmanned aircraft does not immediately decelerate and hover to plan a new flight path from the current hover location to the new return flight location and does not restart the return flight from a zero speed flight state until arriving at the new return flight location. Instead, the unmanned aircraft determines a target flight path directly based on the current velocity of the unmanned aircraft, information of the current location, and the location information of the updated return flight location, and control the unmanned aircraft to return flight toward the updated return flight location based on the target flight path. The technical solution of the present disclosure can avoid the occurrence of the issues relating to velocity interruption and the discontinuity of return flight process during the return flight of the unmanned aircraft. The unmanned aircraft may smoothly transition from the original flight path to the newly planned flight path.

### BRIEF DESCRIPTION OF THE DRAWINGS

To better describe the technical solutions of the various embodiments of the present disclosure, the accompanying drawings showing the various embodiments will be briefly described. As a person of ordinary skill in the art would appreciate, the drawings show only some embodiments of the present disclosure. Without departing from the scope of the present disclosure, those having ordinary skills in the art could derive other embodiments and drawings based on the disclosed drawings without inventive efforts.

FIG. 1 is a flow chart illustrating an unmanned aircraft return flight control method, according to an example embodiment.

FIG. 2 is a schematic illustration of a flight path planning, according to an example embodiment.

FIG. 3 is a flow chart illustrating an unmanned aircraft return flight control method, according to another example embodiment.

FIG. 4 is a schematic illustration of a flight path planning, according to another example embodiment.

FIG. 5 is a schematic diagram of an unmanned aircraft return flight control device, according to an example embodiment.

FIG. 6 is a schematic diagram of an unmanned aircraft, according to an example embodiment.

### LISTING OF ELEMENTS

Return flight control device 50
Receiver 51
Processor 52
Unmanned aircraft 600
Electrical motor 607
Propeller 606
Electric speed control 617
Flight controller 618
Sensor system 608
Communication system 610
Supporting device 602
Imaging device 604
Ground terminal 612
Antenna 614
Electromagnetic wave 616

### DETAILED DESCRIPTION OF THE EMBODIMENTS

Next, the technical solutions of the present disclosure will be described in detail with reference to the accompanying drawings. The described embodiments are only some, but not all of the embodiments of the present disclosure. Based on the described embodiments, a person having ordinary skills in the art can modify or improve the various features of the present disclosure without departing from the principle of the various embodiments disclosed herein and without making creative efforts. Such modification or improvement also fall within the scope of the present disclosure.

As used herein, when a first component (or unit, element, member, part, piece) is referred to as “coupled,” “mounted,” “fixed,” “secured” to or with a second component, it is intended that the first component may be directly coupled, mounted, fixed, or secured to or with the second component, or may be indirectly coupled, mounted, or fixed to or with the second component via another intermediate component. The terms “coupled,” “mounted,” “fixed,” and “secured” do not necessarily imply that a first component is permanently coupled with a second component. The first component may be detachably coupled with the second component when these terms are used. When a first component is referred to as “connected” to or with a second component, it is intended that the first component may be directly connected to or with the second component or may be indirectly connected to or with the second component via an intermediate component. The connection may include mechanical and/or electrical connections. The connection may be permanent or detachable. The electrical connection may be wired or wireless. When a first component is referred to as “disposed,” “located,” or “provided” on a second component, the first component may be directly disposed, located, or provided on the second component or may be indirectly disposed, located, or provided on the second component via an intermediate component. When a first component is referred to as “disposed,” “located,” or “provided” in a second component, the first component may be partially or entirely disposed, located, or provided in, inside, or within the second component. The terms “perpendicular,” “horizontal,” “vertical,” “left,” “right,” “up,” “upward,” “upwardly,” “down,” “downward,” “downwardly,” and similar expressions used herein are merely intended for describing relative positional relationship.

Unless otherwise defined, all the technical and scientific terms used herein have the same or similar meanings as generally understood by one of ordinary skill in the art. As described herein, the terms used in the specification of the present disclosure are intended to describe example embodiments, instead of limiting the present disclosure. The term “and/or” used herein includes any suitable combination of one or more related items listed.

The terms “comprise,” “comprising,” “include,” and the like specify the presence of stated features, steps, operations, elements, and/or components but do not preclude the presence or addition of one or more other features, steps, operations, elements, components, and/or groups. The term “communicatively couple(d)” or “communicatively connect(ed)” indicates that related items are coupled or connected through a communication channel, such as a wired or wireless communication channel. The term “unit,” “sub-unit,” or “module” may encompass a hardware component, a software component, or a combination thereof. For example, a “unit,” “sub-unit,” or “module” may include a housing, a device, a sensor, a processor, an algorithm, a circuit, an electrical or mechanical connector, etc. The term “processor” may include any suitable processor, which may include hardware, software, or a combination thereof. The processor may be a generic processor or a dedicated processor, which may be specifically programmed to perform certain functions.

The symbol “/” means “or” between the related items separated by the symbol. The phrase “at least one of” A, B, or C encompasses all combinations of A, B, and C, such as A only, B only, C only, A and B, B and C, A and C, and A, B, and C. The term “and/or” may be interpreted as “at least one of”

Next, embodiments of the present disclosure will be described in detail with reference to the accompanying drawings. Unless there is obvious conflict, these embodiments and the features included in these embodiments may be combined in any suitable manner.

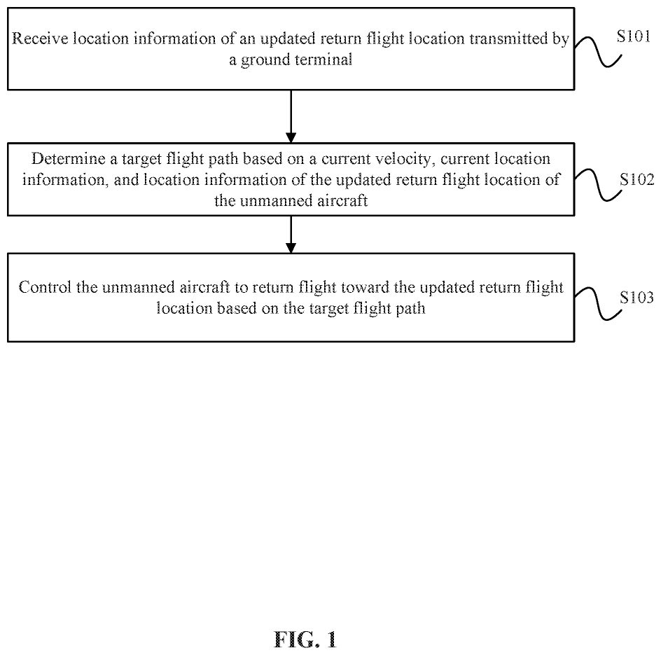

The present disclosure provides an unmanned aircraft return flight control method. FIG. 1 is a flow chart illustrating an unmanned aircraft return flight control method. As shown in FIG. 1, the method may include:

Step S101: receiving location information of an updated return flight location transmitted by a ground terminal.

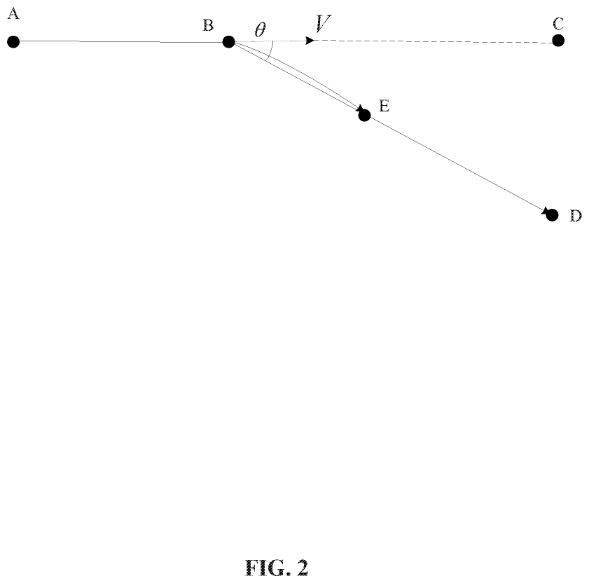

As shown in FIG. 2, the unmanned aircraft may start the return flight at location A. The return flight location or point, i.e., the home location, is C. At location A, the unmanned aircraft may plan a flight path from location A to location C. The planning method may use a point-to-point return flight path planning algorithm. In some embodiments, the flight path may be planned from the following three aspects. The first aspect is to plan location information of any location point on the flight path of the unmanned aircraft. The second aspect is to plan a velocity of the unmanned aircraft at any location point on the flight path. The third aspect is to plan a time instance at any location point on the flight path of the unmanned aircraft. The purpose of the flight path AC planning is to cause the unmanned aircraft to fly at the planned velocity to arrive at a planned location point at a planned time instance, until the unmanned aircraft arrives at the return flight point C. However, the return flight location may be changed. That is, the return flight location C may be a return flight location of a previous time instance for the unmanned aircraft. At a later time instance, the return flight location for the unmanned aircraft may become location D, or another location. The updated return flight location may include the following possible situations:

One possible situation: the return flight location may be changed in real time. For example, the ground terminal may be provided with a positioning device. The positioning device may be a Global Positioning System (“GPS”), a Beidou, a vision sensor, etc. The ground terminal may be a remote controller, a smart cell phone, a tablet computer, a laptop computer, an ultra-mobile personal computer (“UMPC”), a network pad, a personal digital assistant (“PDA”), or any combination thereof. The positioning device of the ground terminal may provide positioning of the location of the ground terminal in real time. If a user holds the ground terminal and moves around, the location information detected by the positioning device may change in real time. The ground terminal may transmit the location information that changes in real time to the unmanned aircraft. The location point identified by the location information that changes in real time may be the return flight location that is updated in real time.

Another possible situation: the return flight location may be updated periodically. For example, the ground terminal may periodically transmit positioning information of the location of the ground terminal to the unmanned aircraft.

Another possible situation: the return flight location may be updated based on a displacement of the ground terminal. For example, when the location of the ground terminal changes, and when the distance between the current location and the original location point of the ground terminal is greater than a predetermined distance, the ground terminal may transmit positioning information of the current location point of the ground terminal to the unmanned aircraft. The current location point of the ground terminal may be the new return flight location of the unmanned aircraft.

A further possible situation: the return flight location may be updated based on the moving velocity of the ground terminal. For example, when the user holding the ground terminal moves in a velocity greater than a predetermined velocity, the ground terminal may transmit positioning information of the current location point of the ground terminal to the unmanned aircraft.

In the embodiment shown in FIG. 2, location D is used as the new return flight location of the unmanned aircraft. The present disclosure does not limit the reason to generate the new return flight location D of the unmanned aircraft.

Step S102: determining a target flight path based on a current velocity, current location information, and location information of the updated return flight location of the unmanned aircraft.

As shown in FIG. 2, the unmanned aircraft may fly along the flight path AC, and at a certain time instance, the location of the ground terminal changed. The return flight location of the unmanned aircraft may become location D. When the unmanned aircraft receives positioning information of the location D transmitted by the ground terminal, the unmanned aircraft arrives at location B. At this moment, the current location point of the unmanned aircraft is B, and the updated return flight location is D. The current velocity is V. The direction of V and the direction of the flight path AC may be consistent. The unmanned aircraft may plan a new flight path (i.e., a target flight path) based on the current velocity V, location information of location B, and location information of location D. The target flight path is the trajectory of the unmanned aircraft from the current location to the updated return flight location. In some embodiments, the target flight path may be a trajectory from location B to location D. The trajectory may be a straight line or a curved line. Using the straight line as an example, as shown in FIG. 2, the flight path from location B pointing to location D is the target flight path BD. The planning of the target flight path BD may be performed from the following three aspects. The first aspect is to plan location information of the unmanned aircraft at any location point on the target flight path BD, the second aspect is to plan the velocity of the unmanned aircraft at any location point on the target flight path BD, and the third aspect is to plan the time instance when the unmanned aircraft is located at any location point on the target flight path BD. That is, the purpose of the planning of the target flight path BD is to make the unmanned aircraft to fly to a planned location point at a planned time instance at a planned velocity, until it arrives at the return flight location D.

Step S103: controlling the unmanned aircraft to return flight toward the updated return flight location based on the target flight path.

At location B, the flight controller of the unmanned aircraft may control, based on the target flight path BD, the unmanned aircraft to return flight toward the updated return flight location D. Because the direction of the velocity of the unmanned aircraft at location B and the direction of the original flight path AC are consistent, the angle between the direction of the velocity and the direction of the re-planned target flight path BD may be θ, θ∈(0,180). Then during the process of the flight controller controlling the unmanned aircraft at location B to return flight toward the updated return flight location D, the flight controller may adjust the flight direction of the unmanned aircraft from the direction of the original flight path AC to the direction of the target flight path BD. During the adjusting process, the unmanned aircraft may smoothly transition from the original flight path AB to the target flight path BD following the trajectory indicated by the curve BE.

In some embodiments, when the unmanned aircraft receives location information of an updated return flight location transmitted by the ground terminal, the unmanned aircraft may not decelerate and hover immediately to re-plan a flight path from the current hover location to the new return flight location, and may not restart the return flight at a zero speed to arrive at the new return flight location. Instead, the unmanned aircraft may determine a target flight path based on a current velocity of the unmanned aircraft, current location information, and location information of the updated return flight location. The unmanned aircraft may control the unmanned aircraft to return flight toward the updated return flight location based on the target flight path, thereby avoiding the occurrence of the issues relating to velocity interruption and the discontinuity of return flight process during the return flight of the unmanned aircraft. The unmanned aircraft may smoothly transition from the original flight path to the newly planned flight path.

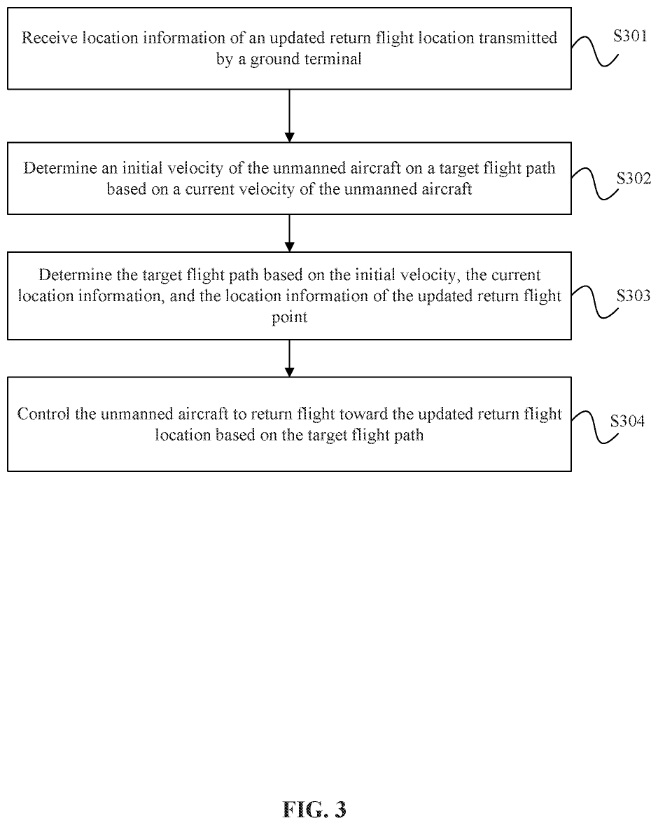

The present disclosure also provides a return flight control method for an unmanned aircraft (or an unmanned aircraft return flight control method). FIG. 3 is a flow chart illustrating a return flight control method for an unmanned aircraft. As shown in FIG. 3, based on the embodiment shown in FIG. 1, this embodiment of the method may include:

Step S301: receiving location information of an updated return flight location transmitted by a ground terminal.

Step S301 may be consistent with step S101. The detailed descriptions of step S301 can refer to those of step S101, which are not repeated.

Step S302: determining an initial velocity of the unmanned aircraft on a target flight path based on a current velocity of the unmanned aircraft.

As shown in FIG. 2, the velocity V of the unmanned aircraft at location B may be consistent with the direction of the original flight path AC, and may form an angle θ with the re-planned target flight path BD. In some embodiments, before planning the target flight path BD, the initial velocity of the unmanned aircraft on the target flight path BD may be determined.

In some embodiments, the unmanned aircraft may determine the initial velocity on the target flight path based on a current velocity, current location information, and location information of an updated return flight location of the unmanned aircraft. For example, the initial velocity of the unmanned aircraft on the target flight path BD may be determined based on the velocity V of the unmanned aircraft at location B, the location information of location B, and the location information of location D. In some embodiments, the initial velocity may be a projection of the current velocity of the unmanned aircraft on the target flight path, i.e., the initial velocity of the unmanned aircraft on the target flight path BD may be a projection of the current velocity V on the target flight path BD.

Correspondingly, an implementation method for determining the initial velocity of the unmanned aircraft on the target flight path based on the current velocity, the current location information, and the location information of the updated return flight location may include: determining an angle between a direction of the current velocity and the target flight path based on the current location information, the location information of the updated return flight location, and the current velocity of the unmanned aircraft; determining the initial velocity of the unmanned aircraft on the target flight path based on the current velocity of the unmanned aircraft and the angle.

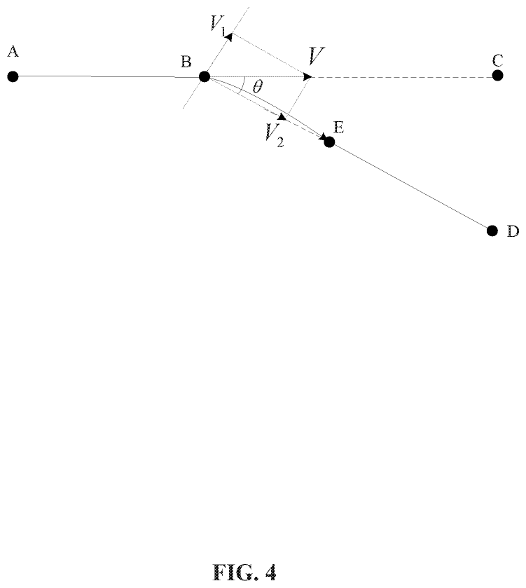

As shown in FIG. 4, the target flight path may be the trajectory BD from the current location B of the unmanned aircraft to the updated return flight location D. The velocity of the unmanned aircraft at location B and the target flight path BD may not be in the same direction. Instead, they may form an angle θ. In some embodiments, the value of the angle θ may be determined based on the direction of the target flight path BD and the direction of the velocity V. In some embodiments, an implementation method for calculating the initial velocity of the unmanned aircraft on the target flight path BD may include: decomposing the velocity V of the unmanned aircraft at location B into a velocity component V1 perpendicular to the target flight path BD and a velocity component V2 parallel with the target flight path BD. The projection of the velocity V of the unmanned aircraft at location B on the target flight path BD is the velocity component V2. The direction of V2 may be consistent with the direction of the target flight path BD. In some embodiments, the projection V2 of the velocity V of the unmanned aircraft at location B on the target flight path BD may be used as the initial velocity of the unmanned aircraft on the target flight path BD.

Step S303: determining the target flight path based on the initial velocity, the current location information, and the location information of the updated return flight point.

In some embodiments, at location B, based on the initial velocity V2 of the unmanned aircraft on the target flight path BD, the location information of the unmanned aircraft at location B, and the location information of the updated return flight location D, the flight controller may plan location information of the unmanned aircraft at any location point on the target flight path BD, velocity of the unmanned aircraft at any location point on the target flight path BD, and a time instance when the unmanned aircraft is located at any location point on the target flight path BD, such that the unmanned aircraft may fly to a planned location point at a planned velocity and at a planned time instance, until the unmanned aircraft arrives at the return flight location D.

Step S304: controlling the unmanned aircraft to return flight toward the updated return flight location based on the target flight path.

Step S304 may be consistent with step S103. The descriptions of step S304 may refer to those of step S103, which are not repeated.

In this embodiment, the projection of the current velocity of the unmanned aircraft on the target flight path may be used as the initial velocity of the unmanned aircraft on the target flight path. In addition, the target flight path may be determined based on the initial velocity, current location information, and location information of an updated return flight location. As a result, the accuracy of the planning of the target flight path is enhanced.

The present disclosure provides a return flight control method for an unmanned aircraft. Based on the embodiments shown in FIG. 1 and FIG. 3, this embodiment of the method may also include: while controlling the unmanned aircraft to return flight toward the updated return flight location, adjusting the flight direction of the unmanned aircraft based on the target flight path, such that the flight direction of the unmanned aircraft is consistent with the direction of the target flight path.

As shown in FIG. 2, an angle between the direction of the velocity of the unmanned aircraft at location B and the direction of the re-planned target flight path may be θ. Based on the target flight path BD, the flight controller may adjust, during the process of controlling the unmanned aircraft to return flight toward the updated return flight location D, a flight direction of the unmanned aircraft from the direction of the original flight path AC to the direction of the target flight path BD.

In some embodiments, the flight direction of the unmanned aircraft may be adjusted based on the target flight path, such that the aircraft head or aircraft tail of the unmanned aircraft may aim at the updated return flight location. As shown in FIG. 4, if when the unmanned aircraft flies based on the original flight path AC, the aircraft head of the unmanned aircraft aims at the original return flight location C, then when the unmanned aircraft starts flight at location B according to the target flight path BD, the flight controller may control the aircraft head of the unmanned aircraft to gradually aim at the updated return flight location D. If when the unmanned aircraft flies according to the original flight path AC, the aircraft tail of the unmanned aircraft aims at the original return flight location C, then when the unmanned aircraft starts flight at location B according to the target flight path BD, the flight controller may control the aircraft tail of the unmanned aircraft to gradually aim at the updated return flight location D.

In some embodiments, adjusting the flight direction of the unmanned aircraft may be realized using one or more of the following practical methods:

One practical implementation method includes: adjusting the flight direction of the unmanned aircraft based on a predetermined angular velocity. During the process of the flight controller adjusting the flight direction of the unmanned aircraft from the direction of the original flight path AC to the direction of the target flight path BD, the flight controller may adjust the flight direction of the unmanned aircraft based on the predetermined angular velocity. The predetermined angular velocity may be a physical rotation speed not greater than what the unmanned aircraft can bear, such as 150 degrees/second. In other embodiments, the predetermined angular velocity may be 90 degrees/second.

Another practical implementation method may include: determining an angular velocity for adjusting the flight direction of the unmanned aircraft based on an angle between the current flight direction of the unmanned aircraft and the target flight path; and adjusting the flight direction of the unmanned aircraft based on the angular velocity.

In some embodiments, the unmanned aircraft may obtain the current flight direction, determine the angle between the current flight direction and the target flight path based on the current flight direction and the target flight path, and determine the angular velocity for adjusting the flight direction of the unmanned aircraft. The unmanned aircraft may adjust the flight direction of the unmanned aircraft based on the angular velocity. In some embodiments, before the unmanned aircraft receives the location information of the new return flight location transmitted by the control terminal, the flight direction of the unmanned aircraft and the original flight path may be consistent. For example, as shown in FIG. 2 or FIG. 4, the flight direction of the unmanned aircraft at location B may be consistent with the original flight path AC, and may form an angle with the direction of the re-planned target flight path BD. In some embodiments, the angular velocity for adjusting the flight direction of the unmanned aircraft may be determined based on the angle θ. In some embodiments, the angular velocity for adjusting the flight direction of the unmanned aircraft may be 2*θ. For example, θ may be 30 degrees, and the angular velocity may be 60 degrees/second. The flight controller may control the unmanned aircraft to adjust from the flight direction from the direction of the original flight path AC to the direction of the target flight path BD at location B based on an angular velocity of 60 degrees/second. The above descriptions of the angle and the angular velocity are only illustrative. The present disclosure does not limit the detailed relationship between the angle θ and the angular velocity.

In some embodiments, during the process of adjusting the flight direction of the unmanned aircraft, the flight velocity of the unmanned aircraft may be controlled such that during the process of the unmanned aircraft flying from the current location to the updated return flight location, the value of the flight velocity of the unmanned aircraft and the value of the current velocity are consistent.

As shown in FIG. 4, during the process of the flight controller adjusting the flight direction of the unmanned aircraft, the flight controller may control the flight velocity of the unmanned aircraft, such that during the process of the unmanned aircraft flying from the current location B to the updated return flight location D, the value of the flight velocity of the unmanned aircraft and the value of the current velocity V may be consistent. Because during the adjusting process, the unmanned aircraft may smoothly transition from the original flight path AB to the target flight path BD following a trajectory indicated by the curve BE, then during the flight from the current location B to the location E, the flight controller may control the value of the flight velocity of the unmanned aircraft to be consistent with the value of the velocity V of the unmanned aircraft at location B. In addition, during the flight from location E to location D, the flight controller may control the value of the flight velocity of the unmanned aircraft to be consistent with the value of the velocity V of the unmanned aircraft at location B.

According to the present embodiment, during the process of controlling the unmanned aircraft to return flight toward the updated return flight location, the flight direction of the unmanned aircraft may be adjusted based on the target flight path, such that the flight direction of the unmanned aircraft and the direction of the target flight path are consistent. When adjusting the flight direction of the unmanned aircraft, the flight direction of the unmanned aircraft may be adjusted based on the predetermined angular velocity. In some embodiments, the angular velocity for adjusting the flight direction of the unmanned aircraft may be determined based on the angle between the current velocity of the unmanned aircraft and the target flight path, thereby ensuring that the unmanned aircraft may smoothly transition from the original flight path to the target flight path.

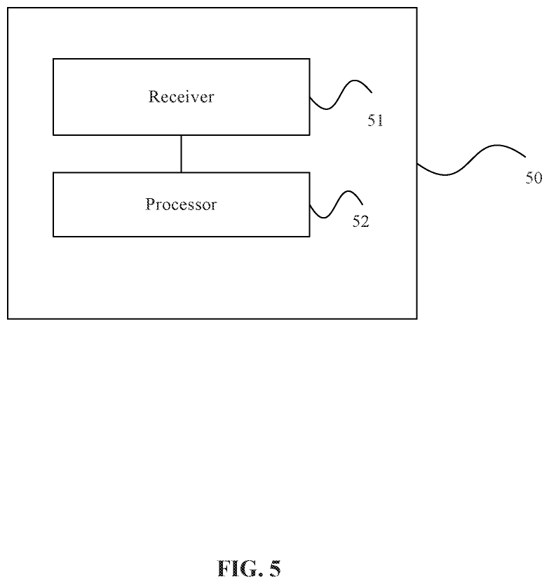

In some embodiments, the present disclosure provides an unmanned aircraft return flight control device. FIG. 5 is a schematic diagram of the unmanned aircraft return flight control device. As shown in FIG. 5, an unmanned aircraft return flight control device 50 may include: a receiver 51 and one or more processors 52. The receiver 51 may be communicatively coupled with the one or more processors 52. The one or more processors 52 may be configured to operate independently or in combination. The receiver 51 may be configured to receive location information of an updated return flight location transmitted by a ground terminal. The one or more processors 52 may be configured to determine a target flight path based on a current velocity, current location information, and location information of the updated return flight location of the unmanned aircraft. The one or more processors 52 may also be configured to control the unmanned aircraft to return flight toward the updated return flight location based on the target flight path.

In some embodiments, the target flight path may be the trajectory from the current location of the unmanned aircraft to the updated return flight location.

In some embodiments, updating the return flight location may include at least one of the following: periodically updating the return flight location; updating the return flight location based on a moving velocity of the ground terminal; or updating the return flight location based on a displacement of the ground terminal.

The detailed principles and the implementation methods of the unmanned aircraft return flight control device may be similar to those of the embodiment shown in FIG. 1, which are not repeated.

In some embodiments, when the unmanned aircraft receives the location information of the updated return flight location transmitted by the ground terminal, the unmanned aircraft may not need to decelerate and hover immediately to re-plan a flight path from the current hover location to the new return flight location, and to restart the return flight from a zero speed flight state until the unmanned aircraft arrives at the new return flight location. Instead, the unmanned aircraft may determine a target flight path based on the current velocity, current location information, and location information of the updated return flight location of the unmanned aircraft, and may control the unmanned aircraft to return flight toward the updated return flight location based on the target flight path.

In some embodiments, the present disclosure provides an unmanned aircraft return flight control device. Based on the technical solution provided in the embodiment shown in FIG. 5, when the one or more processors 52 determines the target flight path based on the current velocity, the current location information, and the location information of the updated return flight location of the unmanned aircraft, the one or more processors 52 may be configured to: determine an initial velocity of the unmanned aircraft on the target flight path based on the current velocity of the unmanned aircraft; and determine the target flight path based on the initial velocity, the current location information, and the location information of the updated return flight location.

In some embodiments, when the one or more processors 52 determines the initial velocity of the unmanned aircraft on the target flight path based on the current velocity of the unmanned aircraft, the one or more processors 52 may be configured to: determine the initial velocity of the unmanned aircraft on the target flight path based on the current velocity, the current location information, and the location information of the updated return flight of the unmanned aircraft.

In some embodiments, the initial velocity may be a projection of the current velocity of the unmanned aircraft on the target flight path.

Correspondingly, when the one or more processors 52 determines the initial velocity of the unmanned aircraft on the target flight path based on the current velocity, the current location information, and the location information of the updated return flight location, the one or more processors 52 may be configured to: determine the angle between the direction of the current velocity and the target flight path based on the current location information, the location information of the updated return flight location, and the current velocity. The original flight path may be the trajectory from the current location of the unmanned aircraft to the original return flight location. The one or more processors 52 may be configured to: determine the initial velocity of the unmanned aircraft on the target flight path based on the current velocity of the unmanned aircraft and the angle.

The detailed principles and implementation methods of the unmanned aircraft return flight control device may be similar to those of the embodiment shown in FIG. 3, which are not repeated.

In the present embodiment, the projection of the current velocity of the unmanned aircraft on the target flight path may be used as the initial velocity of the unmanned aircraft on the target flight path. The target flight path may be determined based on the initial velocity, the current location information, and the location information of the updated return flight location. As a result, the accuracy of the target flight path planning can be enhanced.

In some embodiments, the present disclosure provides an unmanned aircraft return flight control device. Based on the technical solution provided in the embodiment shown in FIG. 5, the one or more processors 52 may be configured to: during the process of controlling the unmanned aircraft to return flight toward the updated return flight location, adjust the flight direction of the unmanned aircraft based on the target flight path, such that the flight direction of the unmanned aircraft is consistent with the direction of the target flight path.

In some embodiments, when the one or more processors 52 adjusts the flight direction of the unmanned aircraft, the one or more processors 52 may be configured to: adjust the flight direction of the unmanned aircraft based on a predetermined angular velocity.

Alternatively, when the one or more processors 52 adjusts the flight direction of the unmanned aircraft, the one or more processors 52 may be configured to: determine an angular velocity for adjusting the flight direction of the unmanned aircraft based on an angle between the current flight direction of the unmanned aircraft and the target flight path; and adjust the flight direction of the unmanned aircraft based on the angular velocity.

In some embodiments, when the one or more processors 52 adjusts the flight direction of the unmanned aircraft based on the target flight path, such that the flight direction of the unmanned aircraft is consistent with the direction of the target flight path, the one or more processors 52 may be configured to: adjust the flight direction of the unmanned aircraft based on the target flight path such that the aircraft head or the aircraft tail of the unmanned aircraft aims at the updated return flight location.

In some embodiments, the one or more processors 52 may be configured to: during the process of adjusting the flight direction of the unmanned aircraft, control the flight velocity of the unmanned aircraft, such that during the process of the unmanned aircraft flying from the current location toward the updated return flight location, the value of the flight velocity of the unmanned aircraft is consistent with the value of the current velocity.

The detailed principles and the implementation methods of the unmanned aircraft return flight control device may be similar to those of the embodiment shown in FIG. 4, which are not repeated.

In the present disclosure, when the unmanned aircraft is controlled to return flight toward the updated return flight location, the flight direction of the unmanned aircraft may be adjusted, such that the flight direction of the unmanned aircraft and the direction of the target flight path are consistent. When adjusting the flight direction of the unmanned aircraft, the flight direction of the unmanned aircraft may be adjusted based on a predetermined angular velocity. In some embodiments, the angular velocity for adjusting the flight direction of the unmanned aircraft may be determined based on the angle between the current velocity of the unmanned aircraft and the target flight path. Adjusting the flight direction of the unmanned aircraft based on the angular velocity may ensure that the unmanned aircraft can smoothly transition from the original flight path to the target flight path.

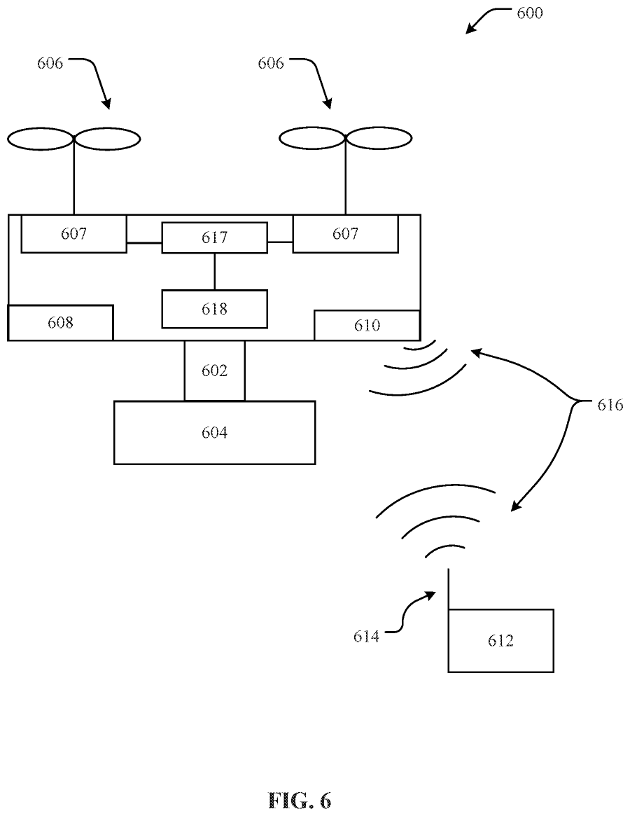

In some embodiments, the present disclosure provides an unmanned aircraft. FIG. 6 is a schematic diagram of an unmanned aircraft. As shown in FIG. 6, an unmanned aircraft 600 may include: an aircraft body, a propulsion system, and a flight controller 618. The propulsion system may include at least one of: an electric motor 607, a propeller 606, and an electric speed control 617. The propulsion system may be mounted on the aircraft body to provide a flight propulsion. The flight controller 618 may be communicatively connected or coupled with the propulsion system, and may be configured to control the flight of the unmanned aircraft. In some embodiments, the flight controller 618 may include an inertial measurement unit and a gyroscope. The inertial measurement unit and the gyroscope may be configured to detect an acceleration, a pitch angle, a roll angle, and a yaw angle of the unmanned aircraft. In some embodiments, the flight controller 618 may be the return flight control device 50.

In some embodiments, as shown in FIG. 6, the unmanned aircraft 600 may include: a sensor system 608, a communication system 610, a supporting device 602, and an imaging device 604. The supporting device 602 may be a gimbal. The communication system 610 may include a receiver configured to receive wireless signals transmitted by an antenna 614 of a ground terminal 612. Reference number 616 refers to the electromagnetic wave generated in the communication between the receiver and the antenna 614.

The detailed principles and implementation methods of the flight controller 618 may be similar to those of the above embodiments, which are not repeated.

According to the present embodiment, when the unmanned aircraft receives location information of an updated return flight location transmitted from a ground terminal, the unmanned aircraft may not need to decelerate and hover immediately to re-plan a flight path from the current hover location to the new return flight location, and to restart the return flight from a zero speed flight state until the unmanned aircraft arrives at the new return flight location. Instead, the unmanned aircraft may determine a target flight path based on the current velocity, the current location information, and the location information of the updated return flight location of the unmanned aircraft, and may control the unmanned aircraft based on the target flight path to return flight toward the updated return flight location. As a result, the occurrence of the issues relating to the velocity interruption and the discontinuity of the return flight process during the return flight of the unmanned aircraft may be avoided. The unmanned aircraft may be ensured to smoothly transition from the original flight path to the newly planned flight path.

From the various embodiments of the present disclosure, a person having ordinary skills in the art can appreciate that the disclosed device and method may be realized using other methods. For example, the above described embodiments of the device are only illustrative. For example, the division of the units is only a division based on the logic functions. In practice, other division methods may be used. For example, multiple units or components may be combined or may be integrated into another system. Some features may be omitted or may not be executed. Further, couplings, direct couplings, or communication connections may be implemented using indirect coupling or communication between various interfaces, devices, or units. The indirect couplings or communication connections between interfaces, devices, or units may be electrical, mechanical, or any other suitable type.

In the descriptions, when a unit or component is described as a separate unit or component, the separation may or may not be physical separation. The unit or component may or may not be a physical unit or component. The separate units or components may be located at a same place, or may be distributed at various nodes of a grid or network. The actual configuration or distribution of the units or components may be selected or designed based on actual need of applications.

Various functional units or components may be integrated in a single processing unit, or may exist as separate physical units or components. In some embodiments, two or more units or components may be integrated in a single unit or component. The integrated unit may be realized using hardware or a combination of hardware and software.

The integrated unit realized in the form of a software functional unit may be stored in a non-transitory computer-readable medium. The above software functional unit may be stored in the storage medium in the form of computer-executable codes or instructions, which when executed by a computer device (e.g., a personal computer, a server, or a network device, etc.) or a processor, may cause the computer device or the processor to perform the various steps of the disclosed methods. The storage medium may include any suitable medium for storing computer program codes or instructions, such as a U disk, a mobile disk, a read-only memory (“ROM”), a random access memory (“RAM”), a magnetic disk, or an optical disk.

A person having ordinary skills in the art can appreciate, for convenience and simplicity of the descriptions, examples of the above divisions of the functional modules are provided. In actual implementations, the functions may be allocated to different functional modules to complete. That is, the internal structure of the device may be divided into different functional modules to carry out some or all of the above-described functions. The detailed operation processes of the above-described device may refer to the corresponding processes of the above-described methods, which are not repeated.

The above-described embodiments are only to explain the technical solutions of the present disclosure, and are not intended to limit the scope of the present disclosure. Although the technical solutions are explained in detail with reference to the above-described various embodiments, a person having ordinary skills in the art can understand: a person having ordinary skills in the art can modify the technical solutions of the various embodiments of the present disclosure, or can make equivalent substitutions for some or all of the technical features. Such modifications, equivalent substitutions, or improvements within the spirit and principle of the present disclosure all fall within the scope of the claims of the present disclosure.

What is claimed is:

1. A method for controlling return flight of an unmanned aircraft, comprising:
receiving location information of an updated return flight location transmitted from a ground terminal;
determining a target flight path based on a current velocity, current location information, and location information of the updated return flight location of the unmanned aircraft; and
controlling the unmanned aircraft to return flight toward the updated return flight location based on the target flight path.

2. The method of claim 1, wherein determining the target flight path based on the current velocity, the current location information, and the location information of the updated return flight location of the unmanned aircraft comprises:
determining an initial velocity of the unmanned aircraft on the target flight path based on the current velocity of the unmanned aircraft; and
determining the target flight path based on the initial velocity, the current location information, and the location information of the updated return flight location.

3. The method of claim 2, wherein determining the initial velocity of the unmanned aircraft on the target flight path based on the current velocity of the unmanned aircraft comprises:
determining the initial velocity of the unmanned aircraft on the target flight path based on the current velocity, the current location information, and the location information of the updated return flight location of the unmanned aircraft.

4. The method of claim 2, wherein the initial velocity is a projection of the current velocity of the unmanned aircraft on the target flight path.

5. The method of claim 3, wherein determining the initial velocity of the unmanned aircraft on the target flight path based on the current velocity, the current location information, and the location information of the updated return flight location of the unmanned aircraft comprises:
determining an angle between a direction of the current velocity and the target flight path based on the current location information, the location information of the updated return flight location, and the current velocity; and
determining the initial velocity of the unmanned aircraft on the target flight path based on the current velocity of the unmanned aircraft and the angle.

6. The method of claim 1, further comprising:
while controlling the unmanned aircraft to return flight toward the updated return flight location, adjusting a flight direction of the unmanned aircraft based on the target flight path to maintain the flight direction of the unmanned aircraft consistent with a direction of the target flight path.

7. The method of claim 6, wherein adjusting the flight direction of the unmanned aircraft comprises:
adjusting the flight direction of the unmanned aircraft based on a predetermined angular velocity.

8. The method of claim 6, wherein adjusting the flight direction of the unmanned aircraft based on the target flight path comprises:
determining an angular velocity for adjusting the flight direction of the unmanned aircraft based on an angle between a current flight direction of the unmanned aircraft and the target flight path; and
adjusting the flight direction of the unmanned aircraft based on the angular velocity.

9. The method of claim 6, wherein adjusting the flight direction of the unmanned aircraft based on the target flight path to maintain the flight direction of the unmanned aircraft to be consistent with the direction of the target flight path comprises:
adjusting the flight direction of the unmanned aircraft based on the target flight path to maintain an aircraft head or aircraft tail of the unmanned aircraft aiming at the updated return flight location.

10. The method of claim 6, further comprising:
while adjusting the flight direction of the unmanned aircraft, controlling a flight velocity of the unmanned aircraft to maintain a value of the flight velocity of the unmanned aircraft consistent with a value of the current velocity.

11. The method of claim 1, wherein the target flight path is a trajectory from a current location of the unmanned aircraft to the updated return flight location.

12. The method of claim 1, wherein the updated return flight location comprises at least one of:
a periodically updated return flight location;
a return flight location updated based on a moving velocity of the ground terminal; or
a return flight location updated based on a displacement of the ground terminal.

13. A device for controlling return flight of an unmanned aircraft, comprising:
a receiver configured to receive location information of an updated return flight location transmitted from a ground terminal; and
one or more processors communicatively coupled with the receiver, the one or more processors configured to operate independently or in combination to:
determine a target flight path based on a current velocity, current location information, and the location information of the updated return flight location of the unmanned aircraft; and
control the unmanned aircraft to return flight toward the updated return flight location based on the target flight path.

14. The device of claim 13, wherein when the one or more processors determine the target flight path based on the current velocity, the current location information, and the location information of the updated return flight location of the unmanned aircraft, the one or more processors are configured to:
determine an initial velocity of the unmanned aircraft on the target flight path based on the current velocity of the unmanned aircraft; and
determine the target flight path based on the initial velocity, the current location information, and the location information of the updated return flight location.

15. The device of claim 14, wherein when the one or more processors determine the initial velocity of the unmanned aircraft on the target flight path based on the current velocity of the unmanned aircraft, the one or more processors are configured to:
determine the initial velocity of the unmanned aircraft on the target flight path based on the current velocity, the current location information, and the location information of the updated return flight location.

16. The device of claim 14, wherein the initial velocity is a projection of the current velocity of the unmanned aircraft on the target flight path.

17. The device of claim 15, wherein when the one or more processors determine the initial velocity of the unmanned aircraft on the target flight path based on the current velocity, the current location information, and the location information of the updated return flight location, the one or more processors are configured to:
determine an angle between a direction of the current velocity and the target flight path based on the current location information, the location information of the updated return flight location, and the current velocity of the unmanned aircraft; and
determine the initial velocity of the unmanned aircraft on the target flight path based on the current velocity of the unmanned aircraft and the angle.

18. The device of claim 13, wherein the one or more processors are also configured to:
while controlling the unmanned aircraft to return flight toward the updated return flight location, adjust a flight direction of the unmanned aircraft based on the target flight path to maintain the flight direction of the unmanned aircraft consistent with a direction of the target flight path.

19. The device of claim 18, wherein the one or more processors are configured to:
while adjusting the flight direction of the unmanned aircraft, control a flight velocity of the unmanned aircraft to maintain a value of the flight velocity consistent with a value of the current velocity during a flight of the unmanned aircraft from a current location to the updated return flight location.

20. The device of claim 13, wherein the target flight path is a trajectory from a current location of the unmanned aircraft to the updated return flight location.
